(19) United States
(12) Patent Application Publication
(10) Pub. No.: US 2025/0384155 A1
(43) Pub. Date: Dec. 18, 2025

(54) ACCESS MANAGEMENT DEVICE, ACCESS MANAGEMENT SYSTEM, STORAGE MEDIUM STORING ACCESS MANAGEMENT PROGRAM, AND ACCESS MANAGEMENT METHOD

(71) Applicant: DENSO CORPORATION, Kariya-city (JP)

(72) Inventor: Masaya ITO, Kariya-city (JP)

(21) Appl. No.: 19/248,006

(22) Filed: Jun. 24, 2025

Related U.S. Application Data
(63) Continuation of application No. PCT/JP2023/046154, filed on Dec. 22, 2023.

(30) Foreign Application Priority Data
Dec. 28, 2022 (JP) 2022-212240

(51) Int. Cl. G06F 21/62; G06F 21/60

(52) U.S. Cl. CPC G06F 21/6218; G06F 21/604

(57) ABSTRACT

An access management device, an access management system, a storage medium storing an access management program, or an access management method stores: a first manifest indicating a correspondence between an application program and a program privilege for accessing an in-vehicle device; and a second manifest indicating a correspondence between a user and a user privilege for accessing the in-vehicle device by using the application program, and transmits the stored first manifest and the stored second manifest to the plurality of vehicles, acquires and stores the first manifest and the second manifest from the server by communication, and manages access to the in-vehicle device.

### CROSS REFERENCE TO RELATED APPLICATIONS

The present application is a continuation application of International Patent Application No. PCT/JP2023/046154 filed on Dec. 22, 2023, which designated the U.S. and claims the benefit of priority from Japanese Patent Application No. 2022-212240 filed on Dec. 28, 2022. The entire disclosures of all of the above applications are incorporated herein by reference.

### TECHNICAL FIELD

The present disclosure relates to a technology for managing access to an in-vehicle device using an application program installed in a vehicle.

### BACKGROUND

A technology has been known for determining whether a user has access privilege when using an application program installed in a vehicle.

For example, in a comparative technology, when an application program for a vehicle that controls a vehicle function is executed, an authentication level and user privilege required for execution are specified. The application program can be used by a user who is authenticated based on the authentication level and user privilege.

The authentication level is expressed, for example, at levels 1 to 3 in order of decreasing security level, depending on the level of security at the time of authenticating the user. The user privilege may be, for example, a vehicle owner, a family member, a guest, a service provider, or the like.

For example, in order to use a certain application program, the authentication level is authentication level 1, and the owner or family is designated as the user privilege.

### SUMMARY

According to an aspect of the present disclosure, an access management device, an access management system, a storage medium storing an access management program, or an access management method stores: a first manifest indicating a correspondence between an application program and a program privilege for accessing an in-vehicle device; and a second manifest indicating a correspondence between a user and a user privilege for accessing the in-vehicle device by using the application program, and transmits the stored first manifest and the stored second manifest to the plurality of vehicles, acquires and stores the first manifest and the second manifest from the server by communication, and manages access to the in-vehicle device.

### BRIEF DESCRIPTION OF THE DRAWINGS

FIG. 1 is a block diagram showing a configuration of an access management system.

FIG. 2 is a block diagram showing a configuration of an access management device.

FIG. 3 is another block diagram showing a configuration of the access management device.

FIG. 4 is an explanatory diagram showing an access privilege relationship between an application program, a user, an in-vehicle device, and data.

FIG. 5 is a sequence diagram showing an access management process.

FIG. 6 is a sequence diagram showing other access management processes.

### DETAILED DESCRIPTION

As a result of detailed study by the inventor, it has been found that, when an application program is used, it is necessary to appropriately manage access of an application program to an in-vehicle device.

One aspect of the present disclosure provides a technology for appropriately managing access to an in-vehicle device using an application program.

According to one aspect of the present disclosure, an in-vehicle access management device manages vehicle data acquired from multiple vehicles and communicates with a server that provides a service related to the multiple vehicles based on the vehicle data, and includes a storage and an access management unit.

The storage stores a first manifest indicating a correspondence between an application program and a program privilege for accessing an in-vehicle device and a second manifest indicating a correspondence between a user and a user privilege for accessing the in-vehicle device by using the application program.

The access management unit manages access by the user to the in-vehicle device using the application program based on the first manifest and the second manifest stored in the storage.

Further, according to another aspect of the present disclosure, an access management system includes a server that manages vehicle data acquired from multiple vehicles and provides services related to the multiple vehicles based on the vehicle data, and an in-vehicle access management device that communicates with the server.

The access management device includes a device storage, an access management unit, and a first management unit.

The device storage stores a first manifest indicating a correspondence between an application program and a program privilege for accessing an in-vehicle device and a second manifest indicating a correspondence between a user and a user privilege for accessing the in-vehicle device by using the application program.

The access management unit manages access by the user to the in-vehicle device using the application program based on the first manifest and the second manifest stored in the device storage. The first management unit manages storage of data received from the server.

The server includes a communication unit, a server storage, and a second management unit.

The communication unit communicates with the vehicle. The second management unit stores the first manifest and the second manifest in the server storage.

The second management unit transmits the first manifest and the second manifest stored in the server storage from the communication unit to the vehicle.

The first management unit stores the first manifest and the second manifest acquired from the server by communication in the device storage.

Further, an access management program according to another aspect of the present disclosure is an access management program that causes a computer to function as the access management device described above.

Further, another access management method according to another aspect of the present disclosure is the access management method by the access management system described above.

According to such a configuration, it is possible to appropriately manage the access to the in-vehicle device based on the first manifest corresponding to the application program and the second manifest corresponding to the user using the application program.

Hereinafter, embodiments of the present disclosure will be described with reference to drawings.

### 1. Configuration

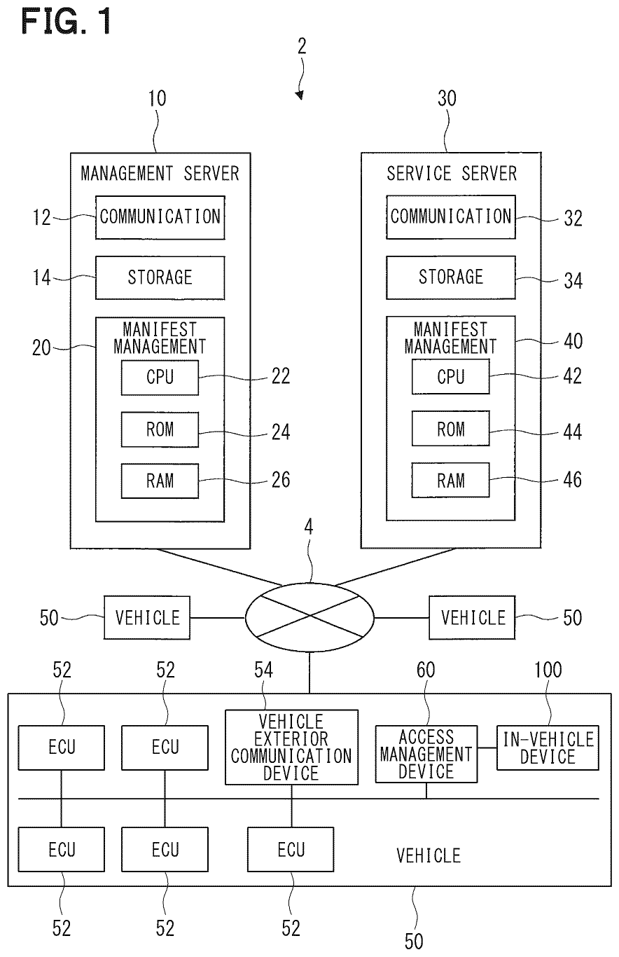

An access management system 2 shown in FIG. 1 includes a management server 10, a service server 30, and an access management device 60. The access management device 60 is mounted on a vehicle 50. Although FIG. 1 shows three vehicles 50, the number of vehicles 50 is not limited to three, and may be multiple vehicles. Each vehicle 50 has a common configuration in that it includes a vehicle exterior communication device 54, the access management device 60, and an in-vehicle device 100.

The management server 10, the service server 30, and the access management device 60 communicate via a network 4.

The management server 10 includes a communication unit 12, a storage 14, and a manifest management unit 20. The management server 10 communicates with the service server 30, the access management device 60, and a portable terminal (not shown) by the communication unit 12. The management server 10 and the service server 30 manage vehicle data acquired from the multiple vehicles 50, and provide vehicle services related to the vehicle 50 based on the vehicle data. The vehicle data includes, for example, the position and vehicle speed of the vehicle 50 and operation data of the vehicle 50 such as steering wheel, accelerator, and brake.

The storage 14 stores a program manifest. The program manifest sets, as the application program, an application program used by a service user 200 described later among application programs installed in the vehicle 50. Hereinafter, an application program may also be referred to as an application or app.

The application installed in the vehicle 50 is installed in the access management device 60 and an in-vehicle electronic control unit 52 described later other than the access management device 60. The application installed in the vehicle 50 is also referred to as an in-vehicle application.

The manifest management unit 20 includes a CPU 22, a ROM 24, a RAM 26, and the like. Various functions of the manifest management unit 20 are implemented by the CPU 22 executing programs stored in a non-transitory tangible storage medium such as the ROM 24. Further, by executing this program, a method corresponding to the program is executed.

The manifest management unit 20 manages the program manifest stored in the storage 14. The program manifest indicates the correspondence between the application and the program privilege, which is the privilege for the application to access the in-vehicle device 100 mounted on the vehicle 50. The in-vehicle device is also referred to as a device. The manifest management unit 20 of the management server 10 is also referred to as a first manifest management unit.

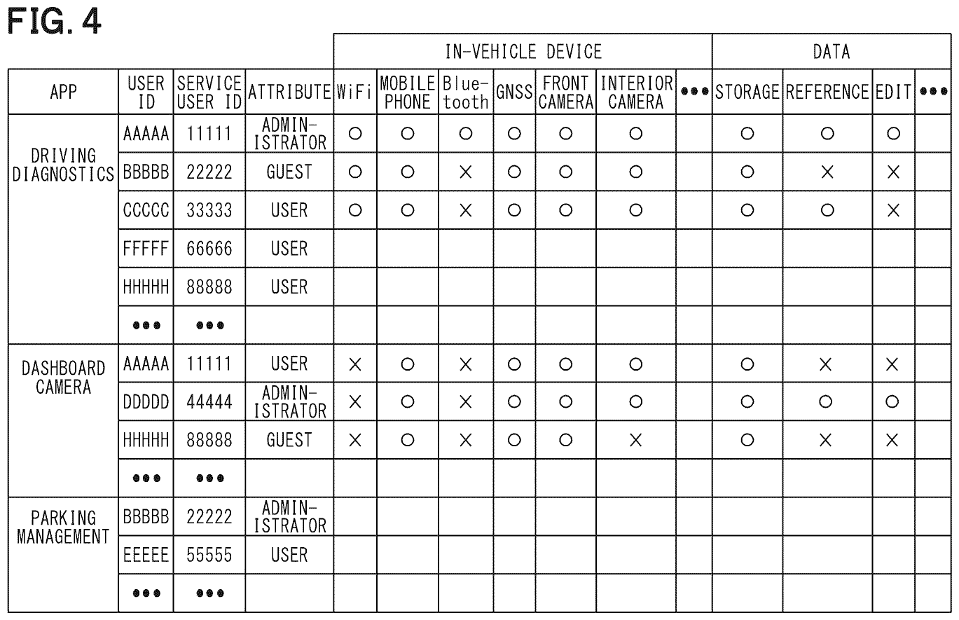

FIG. 4 shows an example of a program manifest showing a correspondence between the application and the program privilege for the application to access the in-vehicle device 100. Circles shown in FIG. 4 indicate that the application has program privilege, that is, can access to the in-vehicle device 100. Crosses shown in FIG. 4 indicate that the application does not have program privilege, that is, cannot access the in-vehicle device 100.

The in-vehicle device 100 is a device related to the vehicle 50. For example, the in-vehicle device 100 is a WiFi communication device for communicating with the management server 10, a Bluetooth communication device for directly communicating with a portable terminal such as a smartphone, a GNSS sensor for detecting a position, a front camera for capturing the outside of the vehicle, and a vehicle interior camera for capturing the inside of the vehicle. WiFi and Bluetooth are registered trademarks. The GNSS is an abbreviation for Global Navigation Satellite System.

As shown in FIG. 1, the in-vehicle device 100 may be not only connected to the access management device 60, but may also be built into the access management device 60 or connected to a bus by being controlled by the electronic control unit 52 to enable communication between the access management device 60 and the electronic control unit 52. The electronic control unit is also referred to as an ECU.

The portable terminal such as a smartphone that can communicate with the management server 10 and the vehicle 50 may be regarded as a part of the in-vehicle device 100, and may be subject to access management.

For example, as shown in FIG. 4, the in-vehicle device 100 accessible by the driving diagnosis application and the in-vehicle device 100 accessible by the drive recorder application are different. In such a manner, a program manifest specifying different access privileges is set depending on the application.

The program manifest is acquired from the management server 10 and stored in a storage 64 of the access management device 60 when the application is installed in the vehicle 50.

The application set in the program manifest may be installed as standard in the vehicle 50, or may not be installed as standard in the vehicle 50, but may be developed and added to the vehicle 50 later.

Further, the in-vehicle device 100 set in the program manifest may be installed as a standard in the vehicle 50, or may not be installed as a standard in the vehicle 50 but may be added to the vehicle 50 later.

The in-vehicle device 100 accessed by the application includes one that the application can access via a private API and one that the application can access via a public API. The API is an abbreviation for Application Programming Interface. The access management device 60 provides the private API and the public API to the application.

The in-vehicle device 100 accessed via the private API requires the access privilege. The access privilege is not required for the in-vehicle device 100 accessed via the public API. Whether to pass through the private API or the public API is determined for each in-vehicle device 100.

Alternatively, the access method to the in-vehicle device 100 may be a method, for example, when the status of the vehicle interior camera is read as the in-vehicle device 100, performing access via the public API. When the power of the vehicle interior camera is turned on or when the image captured by the vehicle interior camera is read, the access may be performed via the private API.

When an application accesses the in-vehicle device 100 via a private API that requires the access privilege, a validity period for access is set. The access validity period is included in the program manifest and managed by the management server 10.

The service server 30 includes a communication unit 32, a storage 34, and a manifest management unit 40. The service server 30 communicates with the management server 10, the vehicle 50, and the portable terminal (not shown) by the communication unit 32.

The manifest management unit 40 includes a CPU 42, a ROM 44, a RAM 46, and the like. Various functions of the manifest management unit 40 are implemented by the CPU 42 executing programs stored in a non-transitory tangible storage medium such as the ROM 44. Further, by executing this program, a method corresponding to the program is executed. The manifest management unit 40 of the service server 30 is also referred to as a second manifest management unit.

The manifest management unit 40 manages the user manifest stored in the storage 34. The user manifest indicates the correspondence between the ID of the service user 200 who uses the application to access the in-vehicle device 100 and a user privilege for the service user 200 to access the in-vehicle device 100.

User IDs shown in FIG. 4 are IDs managed by the service server 30 corresponding to the service user 200. Further, the service user IDs shown in FIG. 4 are IDs managed by the management server 10 corresponding to the user IDs.

The storage 34 stores the user manifest.

Similarly to the program manifest, the in-vehicle device 100 set in the user manifest may be installed as standard in the vehicle 50, or may not be installed as standard in the vehicle 50 but may be added to the vehicle 50 later.

FIG. 4 shows an example of correspondence between the service user 200 and the user privilege for the service user 200 to access the in-vehicle device 100. As shown in FIG. 4, the user privilege includes, in addition to the access privilege to the in-vehicle device 100, privilege related to how to access the data of the in-vehicle device 100 that the service user 200 can access, such as whether to store, refer to, or edit the data.

In addition, the user privilege may include authority regarding data items and data types indicating which data in the in-vehicle device 100 that the service user 200 can access can be accessed.

The circles shown in FIG. 4 indicate that there is the user privilege, and the crosses indicate that there is no user privilege.

For example, as shown in FIG. 4, the in-vehicle device 100 accessible by the administrator who is the user is different from the in-vehicle device 100 accessible by the guest. In this way, different user manifests are set according to the user.

As shown in FIG. 4, the program manifest and the user manifest may be set as one manifest. On the other hand, the program manifest and the user manifest may be set as separate manifests.

As shown in FIG. 4, the user privilege of the driving diagnosis application is different between the in-vehicle device 100 that can be accessed when the user attribute is administrator and the in-vehicle device 100 that can be accessed when the user attribute is guest. The user privilege of the drive recorder application is different between the in-vehicle device 100 that can be accessed when the user is the administrator and the in-vehicle device 100 that can be accessed when the user is a guest.

The storage 34 stores data other than the user manifest described above.

In addition to the above, the user privilege includes, for example, the following privileges (1) and (2).
(1) The multiple in-vehicle devices 100 that the application can access may include the in-vehicle device 100 that the user can access.
(2) As operations permitted for the in-vehicle device 100, for example, the in-vehicle device 100 can start and end.

The vehicle 50 includes multiple ECUs 52 that execute vehicle control, the vehicle exterior communication device 54 that communicates with the outside of the vehicle 50 via the network 4 or the like, an access management device 60, and an in-vehicle device 100. The ECU is an abbreviation for Electronic Control Unit.

The ECU 52 includes one or more microcomputers and executes vehicle control. The vehicle exterior communication device 54 communicates with the outside of the vehicle 50 via the network 4 or the like.

The access management device 60 manages the access of the service user 200 to the in-vehicle device 100 using the in-vehicle application.

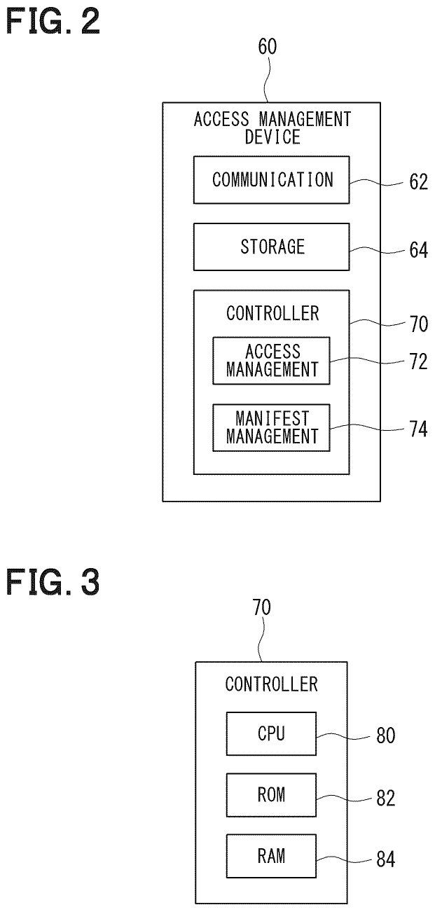

As shown in FIG. 2, the access management device 60 includes a communication unit 62, the storage 64, and a controller 70. The controller 70 includes an access management unit 72 and a manifest management unit 74. The access management device 60 communicates with the management server 10 and the service server 30 via the communication unit 62.

As shown in FIG. 3, the controller 70 includes a CPU 80, a ROM 82, a RAM 84, and the like as a hardware configuration. Various functions including the access management unit 72 and the manifest management unit 74 of the controller 70 are implemented by the CPU 80 executing a program stored in a non-transitory tangible storage medium such as the ROM 82. Further, by executing this program, a method corresponding to the program is executed.

The access management unit 72 manages the access of the service user 200 to the in-vehicle device 100 using the in-vehicle application based on the program manifest and the user manifest stored in the storage 64. Further, the access management unit 72 manages and provides the private API and the public API described above.

The program manifest stored in the storage 64 defines, as the in-vehicle application, the correspondence between the application installed in the access management device 60 and the ECU 52 other than the access management device 60 and the program privilege with which the in-vehicle application accesses the in-vehicle device 100.

That is, in the vehicle 50, the access management device 60 centrally manages the access of the service user 200 to the in-vehicle device 100 using the in-vehicle application based on the program manifest and the user manifest.

The manifest management unit 74 stores the program manifest acquired from the management server 10 and the user manifest acquired from the service server 30 in the storage 64.

The manifest management unit 74 may receive an integration manifest integrating the program manifest and the user manifest from the management server 10 that has acquired the user manifest from the service server 30, and store it in the storage 64. The manifest management unit 74 in the access management device 60 of the vehicle 50 is also referred to as a third manifest management unit.

As shown in FIG. 4, the integration manifest is a manifest in which the access privilege to the in-vehicle device 100 is set for each application and for each user or attribute of the user indicated by the user ID.

The user attributes are set for one or more users having the same attributes. The user attributes indicate, for example, the level of access to the in-vehicle device 100. The higher the access level, the more in-vehicle devices 100 can be accessed, or the more specific in-vehicle devices 100 can be accessed.

Further, the integration manifest may be divided for each application and stored in the storage 64. For example, the driving diagnosis application has a manifest in which the access privilege for each user or user attribute is set for the driving diagnosis application, and the drive recorder application has a manifest in which the access privilege for each user or user attribute is set for the drive recorder application.

The manifest management unit 74 stores the manifests of these applications in the storage 64 when the applications are installed in the vehicle 50. Each application refers to the manifest about its application stored in the storage 64, and requests access to the in-vehicle device 100 using the private API or public API based on user attributes.

The application installed in the vehicle 50 is stored in the access management device 60 and the other ECU 52, and installed.

### 2. Process

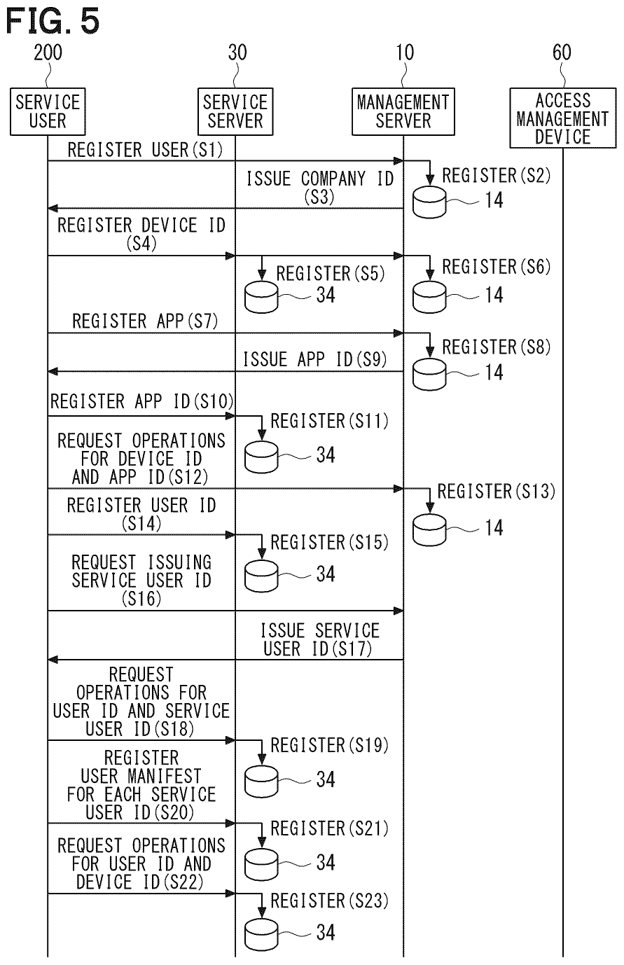

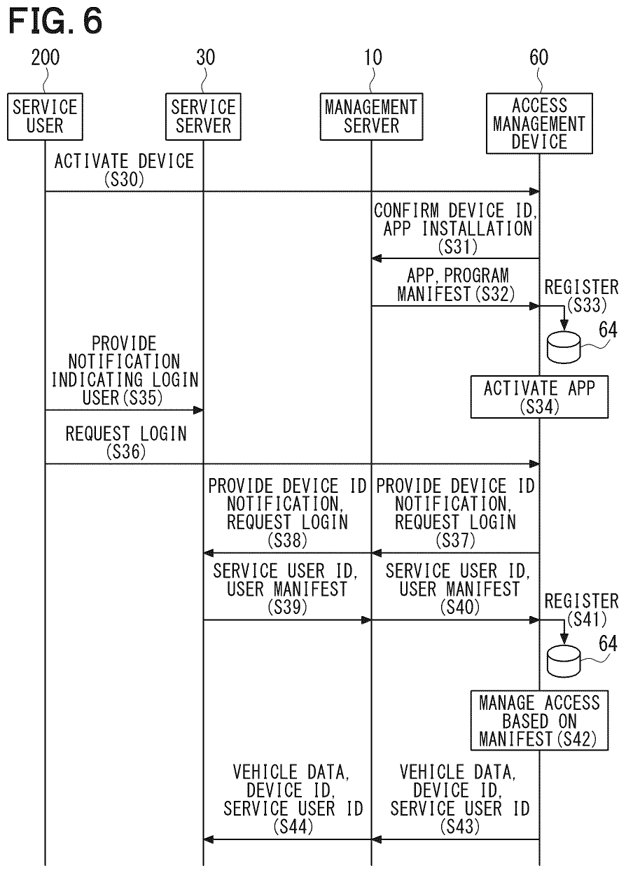

Next, the access management process executed by the access management system 2 will be described with reference to sequence diagrams of FIG. 5 and FIG. 6. The service user 200 shown in FIG. 5 is, for example, a company that develops or uses an application, a driver who is an employee of the company and is in the vehicle 50, a manufacturer of the vehicle 50, or a management company that manages the data of the vehicle 50.

### (1) Pre-Process

The access management process shown in FIG. 5 is executed between the management server 10, the service server 30, and the service user 200 as a pre-process before the service user 200 uses the application. The process of the service user 200 is executed via an information processing terminal such as a smartphone or a PC.

In S1 of FIG. 5, the service user 200 applies to register the service user 200 with the management server 10. For example, a business name is applied as the service user 200.

In S2, the manifest management unit 20 of the management server 10 stores the applied business name in the storage 14 and registers it. In S3, the manifest management unit 20 of the management server 10 issues the ID of the service user 200 to the service user 200. When the service user 200 is a company operator, a company ID is issued.

In S4, the service user 200 applies to register a device ID of the in-vehicle device 100 used in the vehicle 50 in the management server 10 and the service server 30. In S5, the manifest management unit 40 of the service server 30 stores the device ID applied for by the service user 200 in the storage 34 and registers it.

In S6, the manifest management unit 20 of the management server 10 stores the device ID applied for by the service user 200 in the storage 14 and registers it. When the in-vehicle device 100 indicated by the device ID registered in the storage 14 passes through a private API that requires access privilege, the manifest management unit 20 of the management server 10 stores and registers, in the storage 14, the validity period for accessing the in-vehicle device 100.

In S7, the service user 200 applies to register the application developed by the service user 200 in the management server 10. In S8, the manifest management unit 20 of the management server 10 stores the application applied from the service user 200 in the storage 14 and registers it. In S9, the manifest management unit 20 of the management server 10 issues the ID of the application applied from the service user 200 to the service user 200.

In S10, the service user 200 applies to register an application ID issued from the management server 10 with the service server 30. In S11, the manifest management unit 40 of the service server 30 stores the application ID applied for by the service user 200 in the storage 34 and registers it.

In S12, the service user 200 applies to the management server 10 to register the application ID registered in the management server 10 and the device ID of the in-vehicle device 100 used by the application indicated by the application ID in association with each other.

In S13, the manifest management unit 20 of the management server 10 associates the application ID stored in the storage 14 with the device ID, stores it in the storage 14 and registers it as a program manifest.

In S14, the service user 200 applies to the service server 30 to register the user ID set for each employee of the provider, for example. In S15, the manifest management unit 40 of the service server 30 stores the user ID applied for by the service user 200 in the storage 34 and registers it.

In S16, the service user 200 applies to the management server 10 to issue a service user ID for the number of requests. In S17, the manifest management unit 20 of the management server 10 issues the requested number of service user IDs to the service user 200.

In S18, the service user 200 applies to the service server 30 to register the correspondence between the user ID and the service user ID. In S19, the manifest management unit 40 of the service server 30 stores and registers the correspondence relationship between the applied user ID and the service user ID in the storage 34.

The service user ID is set corresponding to the user ID and managed by the management server 10. The user ID is managed by the service server 30. In the example shown in FIG. 4, the user ID and the service user ID correspond on a one-to-one basis, but multiple user IDs may correspond to one service user ID.

In S20, the service user 200 applies to the service server 30 to register the user manifest corresponding to each service user ID set in the service user 200. In S21, the manifest management unit 40 of the service server 30 stores the user manifest for each service user ID in the storage 34 and registers it. In S22, the service user 200 applies to the service server 30 to register the correspondence between the user ID and the device ID used by the user, for example, based on a utilization schedule indicating a time when the service user 200 gets into the vehicle 50.

In S23, the manifest management unit 40 of the service server 30 stores and registers the correspondence relationship between the applied user ID and the service user ID in the storage 34.

### (2) Process at Use Time

The access management process shown in FIG. 6 is executed between the management server 10, the service server 30, the access management device 60, and the service user 200 as processes when the service user 200 uses the application.

In S30, the service user 200 activates the access management device 60, for example, by turning on the start switch of the vehicle 50.

In S31, the access management unit 72 of the access management device 60 checks with the management server 10 whether there is an application that is not installed in the vehicle 50. When there is the application that is not installed, the access management unit 72 the in-vehicle device 100 used by the application with the management server 10.

When there is the application that is not installed in the vehicle 50, in S32, the manifest management unit 20 of the management server 10 transmits the application that is not installed and the program manifest corresponding to the application to the vehicle 50.

The program manifest sets a validity period for accessing the in-vehicle device 100 when the in-vehicle device 100 is accessed via the private API that requires access privilege. The program manifest is transmitted to the vehicle 50 before or at the same time as installation of the application.

In S33, the manifest management unit 74 of the access management device 60 stores the application received from the management server 10 in the storage 64 or a storage (not shown) of another ECU 52 other than the storage 64 and registers it.

Furthermore, in S33, the manifest management unit 74 of the access management device 60 stores the program manifest received from the management server 10 in the storage 64 and registers it. The program manifest has the above-described validity period.

In S34, the access management unit 72 of the access management device 60 activates the application managed by the access management unit 72. When the program manifest is not stored normally, the access management unit 72 does not activate the application or prohibits the application from accessing all the in-vehicle devices 100 even when the application is activated.

In S35, the service user 200 notifies the service server 30 of logging in with a user ID using a portable terminal or the like.

In S36, the service user 200 requests the access management device 60 to log in with the user ID using the portable terminal or the like. In S37 and S38, the access management unit 72 of the access management device 60 notifies the management server 10 and the service server 30 of the user ID and the device ID used for the user ID as user information to log in, and requests the login. The access management unit 72 may request the management server 10 to log in, and the management server 10 may request the service server 30 to log in.

The service server 30 requested to log in from the vehicle 50 reads the service user ID corresponding to the user ID and the user manifest corresponding to the service user ID from the storage 34. Then, in S39 and S40, the service server 30 transmits the service user ID and the corresponding user manifest to the management server 10 and the vehicle 50. The user manifest is transmitted to the vehicle 50 in response to a login request from the vehicle 50.

The service server 30 may transmit the service user ID and the user manifest corresponding to the service user ID to the management server 10, and the management server 10 may transmit them to the vehicle 50. The user manifest may be one in which the access privilege to the in-vehicle device 100 is specified for the service user ID. Further, the user manifest may specify attributes for the service user ID and access privileges to the in-vehicle device 100 for attributes.

In S41, the manifest management unit 74 of the access management device 60 stores the service user ID and the user manifest received from the service server 30 in the storage 64.

In S42, the access management unit 72 manages the access by the service user 200 to the in-vehicle device 100 using the application based on the program manifest and the user manifest stored in the storage 64.

In S43 and S44, the access management device 60 transmits the service user ID, the device ID used by the service user 200 indicated by the service user ID, and the vehicle data acquired from the in-vehicle device 100 indicated by the device ID to the management server 10 and the service server 30.

In the embodiment described above, the management server 10 and the service server 30 correspond to a server, the communication unit 12 corresponds to a first communication unit, and the communication unit 32 corresponds to a second communication unit.

The manifest management unit 20 and the manifest management unit 40 correspond to a second management unit, the manifest management unit 20 corresponds to a third management unit, the manifest management unit 40 corresponds to a fourth management unit, and the storages 14 and 34 correspond to a server storage. The storage 14 corresponds to a first server storage, the storage 34 corresponds to a second server storage, and the storage 64 corresponds to a device storage. Further, the manifest management unit 74 corresponds to a first management unit.

Further, the program manifest corresponds to a first manifest, the user manifest corresponds to a second manifest, the private API corresponds to a first API, and the public API corresponds to a second API.

Further, S13 corresponds to a process of the third management unit of the management server, S21 corresponds to a process of the fourth management unit of the service server, S33 and S41 correspond to a process of the manifest management unit of the access management device, and S42 corresponds to a process of the access management unit of the access management device.

### 3. Effects

The embodiment described above provides the following effects.
(3a) It is possible to appropriately manage the access of the application to the in-vehicle device 100 based on the program manifest and the user manifest.
(3b) For the application and the in-vehicle device 100 installed as standard in the vehicle 50, the program manifest and the user manifest are also set for the added application and the in-vehicle device 100. Accordingly, for the added application and the in-vehicle device 100, it is possible to appropriately manage the access of the application to the in-vehicle device 100 based on the program manifest and the user manifest.

### 4. Other Embodiments

Although the embodiment of the present disclosure has been described above, the present disclosure is not limited to the above-described embodiments, and various modifications can be made.
(4a) In the embodiment described above, the access management device 60 stores the application used by the service user 200 in the storage 64 of the access management device 60. However, the access management device 60 may store the application in a storage (not shown) of another ECU 52 other than the storage 64.
(4b) In the embodiment described above, two servers, the management server 10 and the service server 30, are set as the servers. However, the functions of the management server 10 and the service server 30 may be combined into one server.
(4c) In the embodiment described above, the in-vehicle application that is the target for the access management device 60 to manage access to the in-vehicle device 100 is set to the application installed in the access management device 60 and the ECU 52 other than the access management device 60.

Not limited to this, the in-vehicle application for which the access management device 60 manages access to the in-vehicle device 100 may be an application installed in at least one of the access management device 60 or the ECU 52 other than the access management device 60.

In this case, the program manifest may specify the correspondence between the target in-vehicle application for which the access management device 60 manages access to the in-vehicle device 100 and the program privilege for the application to access the in-vehicle device.
(4d) The access management device 60 and the method thereof described in the present disclosure may be implemented by a dedicated computer provided by configuring a processor and a memory programmed to execute one or multiple functions embodied by a computer program.

Alternatively, the access management device 60 and the method thereof according to the present disclosure may be implemented by a dedicated computer provided by constituting a processor with one or more dedicated hardware logic circuits.

Alternatively, the access management device 60 and the method thereof described in the present disclosure may be implemented by one or more dedicated computers configured by a combination of a processor and a memory programmed to execute one or multiple functions and a processor configured by one or more hardware logic circuits.

Furthermore, the computer program may be stored in a computer-readable non-transitory tangible storage medium as an instruction executed by the computer. The method for implementing the functions of the respective units included in the access management device 60 does not necessarily need to include software, and all of the functions may be implemented with the use of one or multiple hardware.
(4e) The multiple functions of one component in the above embodiments may be implemented by multiple components, or a function of one component may be implemented by multiple components. In addition, multiple functions of multiple components may be implemented by one component, or a single function implemented by multiple components may be implemented by one component. A part of the configuration of the above embodiment may be omitted as appropriate. At least a part of the configuration of the above embodiment may be added to or replaced with another configuration of the above embodiment.
(4f) In addition to the access management device 60 described above, the present disclosure can be implemented in various forms such as the access management system 2 having the access management device 60 as a configuration element, the access management program for causing a computer to function as the access management device 60, a non-transitory tangible storage medium such as a semiconductor memory storing the program, and an access management method by the access management system 2 or the access management device 60.

What is claimed is:

1. An in-vehicle access management device configured to manage vehicle data acquired from a plurality of vehicles and communicate with a server configured to provide a service related to the plurality of vehicles based on the vehicle data, the in-vehicle access management device comprising:
a storage configured to store
a first manifest indicating a correspondence between an application program and a program privilege for accessing an in-vehicle device and
a second manifest indicating a correspondence between a user and a user privilege for accessing the in-vehicle device by using the application program; and
at least one of (i) a circuit and (ii) a processor with a memory storing computer program code executable by the processor, the at least one of the circuit and the processor configured to cause the in-vehicle access management device to serve as
an access management unit configured to manage access by the user to the in-vehicle device using the application program based on the first manifest and the second manifest stored in the storage.

2. The in-vehicle access management device according to claim 1, wherein
the user privilege indicates at least one of the in-vehicle device that is accessible by the user and accessible by the application program, data related to the in-vehicle device accessible by the user, or an operation permitted on the in-vehicle device accessible by the user.

3. The in-vehicle access management device according to claim 1, wherein
the at least one of the circuit and the processor is further configured to cause the in-vehicle access management device to: serve as a manifest management unit configured to
acquire the first manifest corresponding to the application program from the server by communication, and
store the first manifest in the storage when acquiring the application program from the server by the communication.

4. The in-vehicle access management device according to claim 1, wherein
the at least one of the circuit and the processor is further configured to cause the in-vehicle access management device to serve as a manifest management unit configured to store, in the storage, the second manifest acquired by communication from the server based on information of the user.

5. The in-vehicle access management device according to claim 1, wherein
the access management unit is further configured to provide a first application programming interface that requires an access privilege to the in-vehicle device and a second application programming interface that does not require the access privilege to the in-vehicle device when accessing the in-vehicle device.

6. The in-vehicle access management device according to claim 5, wherein
when the user accesses the in-vehicle device requiring the access privilege by using the application program, the access management unit acquires a validity period of the access privilege by communication from the server, and permits the user to access the in-vehicle device requiring the access privilege by using the application program during the acquired validity period.

7. The in-vehicle access management device according to claim 1, wherein
the first manifest specifies a correspondence between
the application program installed in the access management device and an in-vehicle electronic control unit other than the access management device and
the program privilege for the application program to access the in-vehicle device.

8. An access management system comprising:
a server configured to manage vehicle data acquired from a plurality of vehicles and provide a service related to the plurality of vehicles based on the vehicle data; and
an in-vehicle access management device configured to communicate with the server,
wherein
the in-vehicle access management device includes:
a device storage configured to store
a first manifest indicating a correspondence between an application program and a program privilege for accessing an in-vehicle device and
a second manifest indicating a correspondence between a user and a user privilege for accessing the in-vehicle device by using the application program; and
at least one of (i) a first circuit and (ii) a first processor with a first memory storing first computer program code executable by the first processor, the at least one of the first circuit and the first processor configured to cause the in-vehicle access management device to serve as:
an access management unit configured to manage access by the user to the in-vehicle device using the application program based on the first manifest and the second manifest stored in the device storage; and
a first management unit configured to manage storage of data received from the server,
the server includes:
a server storage; and
at least one of (i) a second circuit and (ii) a second processor with a second memory storing second computer program code executable by the second processor, the at least one of the second circuit and the second processor configured to cause the server to serve as:
a communication unit configured to communicate with the plurality of vehicles; and
a second management unit configured to store the first manifest and the second manifest in the server storage,
the second management unit is configured to transmit the first manifest and the second manifest stored in the server storage from communication unit to the plurality of vehicles, and
the first management unit is configured to store the first manifest and the second manifest acquired from the server by communication in the device storage.

9. The access management system according to claim 8, wherein
the second management unit transmits the first manifest that corresponds the application program and is stored in the server storage to at least one of the plurality of vehicles when transmitting the application program from the communication unit to the at least one of the plurality of vehicles, and
when acquiring the application program from the server by communication, the first management unit acquires the first manifest corresponding to the application program from the server by the communication and stores the first manifest in the device storage.

10. The access management system according to claim 8, wherein
the at least one of the second circuit and the second processor is further configured to cause the server to serve as:
a management server; and
a service server,
the second management unit includes a third management unit and a fourth management unit,
the server storage includes a first server storage and a second server storage, the management server includes:
a first communication unit configured to communicate with the plurality of vehicles as the communication unit;
the first server storage that is the server storage and stores the first manifest; and
the third management unit configured to store the first manifest in the first server storage,
the service server includes:
a second communication unit configured to communicate with the plurality of vehicles as the communication unit;
the second server storage that is the server storage and configured to store the second manifest in the server storage; and
the fourth management unit configured to store the second manifest in the second server storage,
the third management unit is configured to transmit the first manifest stored in the first server storage from the first communication unit to the plurality of vehicles,
the fourth management unit is configured to transmit the second manifest stored in the second server storage from the second communication unit to the plurality of vehicles, and
the first management unit stores the first manifest acquired by communication from the management server in the device storage, and stores the second manifest acquired by the communication from the service server in the device storage.

11. A non-transitory computer-readable storage medium storing an access management program mounted on an in-vehicle access management device configured to manage vehicle data acquired from a plurality of vehicles and cause a computer to communicate with a server that provides a service related to the plurality of vehicles based on the vehicle data, the access management program causing a computer to:
store
a first manifest indicating a correspondence between an application program and a program privilege for accessing an in-vehicle device and
a second manifest indicating a correspondence between a user and a user privilege for accessing the in-vehicle device by using the application program; and
manage access by the user to the in-vehicle device using the application program based on the first manifest and the second manifest stored in the storage.

12. An access management method by an access management system comprising:
a server configured to manage vehicle data acquired from a plurality of vehicles and provide a service related to the plurality of vehicles based on the vehicle data; and
an in-vehicle access management device configured to communicate with the server,
wherein
the method causing the server to
store
a first manifest indicating a correspondence between an application program and a program privilege for accessing an in-vehicle device and
a second manifest indicating a correspondence between a user and a user privilege for accessing the in-vehicle device by using the application program; and
transmit the stored first manifest and the stored second manifest to the plurality of vehicles, and
the method causing the access management device to
acquire and store the first manifest and the second manifest from the server by communication, and
manage access by the user to the in-vehicle device using the application program based on the stored first manifest and the stored second manifest.
